(19) United States
(12) Patent Application Publication
(10) Pub. No.: US 2014/0114852 A1
(43) Pub. Date: Apr. 24, 2014

(54) INSTANT CLEARING AND SETTLEMENT FOR PAYMENT TRANSACTIONS

(71) Applicants: Raj S. Rajagopal, Agoura Hills, CA (US); Larry Jay Thomas, Thousand Oaks, CA (US)

(72) Inventors: Raj S. Rajagopal, Agoura Hills, CA (US); Larry Jay Thomas, Thousand Oaks, CA (US)

(21) Appl. No.: 13/655,307

(22) Filed: Oct. 18, 2012

(51) Int. Cl. G06Q 20/10; G06Q 20/40

(52) U.S. Cl. 705/44; 705/39

(57) ABSTRACT

A method to perform a payment comprises receiving a request from a payer to pay a payee, wherein the request comprises a payer account ID and a payee account ID; receiving, based on the payer account ID, a reservation confirmation that a payment amount is reserved from the payer's payment account; retrieving, based on the payee account ID, a receiving clearing account (RCA) ID identifying an RCA held at the payee financial institution; and initiating, by a computer processor and in response to the reservation confirmation, a settlement process comprising: transferring the payment amount from the RCA to the payee's payment account using a payee electronic funds transfer (EFT) capability of the payee's financial institution within a single business day of receiving the request by the payment service provider; and debiting the payment amount from the payer's payment account to reimburse the RCA.

### SUMMARY

In general, in one aspect, the invention relates to a method to perform a payment. The method comprises: receiving a request from a payer to pay a payee, wherein the request comprises a payer account ID identifying a payer's payment account held at a payer financial institution and a payee account ID identifying a payee's payment account held at a payee financial institution, and wherein the payer financial institution is external to the payee financial institution; receiving, based on the payer account ID, a reservation confirmation that a payment amount is reserved from the payer's payment account; retrieving, based on the payee account ID, a receiving clearing account (RCA) ID identifying an RCA held at the payee financial institution and controlled by a payment service provider; and initiating, by a computer processor and in response to the reservation confirmation, a settlement process comprising: transferring the payment amount from the RCA to the payee's payment account using a payee electronic funds transfer (EFT) capability of the payee's financial institution within a single business day of receiving the request by the payment service provider; and debiting, in response to the transferring, the payment amount from the payer's payment account to reimburse the RCA.

In general, in one aspect, the invention relates to a system to perform a payment. The system comprises: a computer processor; a payer financial institution comprising a payer's payment account controlled by a payer; a payee financial institution, external to the payer financial institution, comprising a payee's payment account controlled by a payee and a receiving clearing account (RCA) controlled by a payment service provider; and a payment platform core executing on the computer processor and configured to: receive a request from a payer to pay a payee, wherein the request comprises a payer account ID identifying a payer's payment account held at a payer financial institution and a payee account ID identifying a payee's payment account held at a payee financial institution; receive, based on the payer account ID, a reservation confirmation that a payment amount is reserved from the payer's payment account; retrieve, based on the payee account ID, a receiving clearing account (RCA) ID identifying an RCA held at the payee financial institution and controlled by the payment service provider; and initiate, in response to the reservation confirmation, a settlement process comprising: transferring the payment amount from the RCA to the payee's payment account using a payee electronic funds transfer (EFT) capability of the payee's financial institution within a single business day of receiving the request by the payment service provider; and debiting, in response to the transferring, the payment amount from the payer's payment account to reimburse the RCA.

In general, in one aspect, the invention relates to a non-transitory computer readable medium storing instructions to perform a payment. The instructions, when executed by a computer processor, comprising functionality for: receiving a request from a payer to pay a payee, wherein the request comprises a payer account ID identifying a payer's payment account held at a payer financial institution and a payee account ID identifying a payee's payment account held at a payee financial institution, and wherein the payer financial institution is external to the payee financial institution; receiving, based on the payer account ID, a reservation confirmation that a payment amount is reserved from the payer's payment account; retrieving, based on the payee account ID, a receiving clearing account (RCA) ID identifying an RCA held at the payee financial institution and controlled by a payment service provider; and initiating, in response to the reservation confirmation, a settlement process comprising: transferring the payment amount from the RCA to the payee's payment account using a payee electronic funds transfer (EFT) capability of the payee's financial institution within a single business day of receiving the request by the payment service provider; and debiting, in response to the transferring, the payment amount from the payer's payment account to reimburse the RCA.

Other aspects of the invention will be apparent from the following detailed description and the appended claims.

### BRIEF DESCRIPTION OF DRAWINGS

FIG. 1 shows a schematic diagram of a system of instant clearing and settlement for payment transactions in accordance with one or more embodiments of the invention.

FIGS. 2A-2C show flowcharts of a method of instant clearing and settlement for payment transactions in accordance with one or more embodiments of the invention.

FIG. 3 shows an example of instant clearing and settlement for payment transactions in accordance with one or more embodiments of the invention.

FIG. 4 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

A deposit account is a transactional account, savings account, or other type of bank account (e.g., an investment account), at a bank or other institution that allows money to be deposited and withdrawn by the account holder. In particular, a transactional account is known as a checking account (or chequeing account) in North America, and as a current account or cheque account in the United Kingdom, Hong Kong, India and some other countries. Because money is available on demand it is also sometimes known as a demand account or demand deposit account (DDA).

In contrast, a credit card holder typically does not deposit and/or withdraw money using the credit card account on a regular basis. For example, the credit card holder is charged a significant fee for cash advance. Authorization hold is the practice within the banking industry of authorizing electronic transactions done with a credit card and holding this balance as unavailable either until the credit card payment services provider clears the transaction (referred to as settlement from the perspective of the issuing bank that issues the credit card to the card holder, and referred to as clearing from the perspective of the payment service provider), or the hold expires. In the case of debit cards, authorization holds can expire (thus rendering the balance available again) within 1-5 business days after the transaction date depending on the bank's policy. In the case of credit cards, authorization holds may last as long as 30 business days, depending on the issuing bank.

Automated Clearing House (ACH) is an electronic network for financial transactions in the United States. Rules and regulations that govern the ACH network are established by NACHA (formerly the National Automated Clearing House Association) and the Federal Reserve. An ACH transaction starts with a receiver authorizing an originator to issue an ACH debit or credit to an account. A receiver is the account holder that grants the authorization. An originator can be a person or a company (such as the gas company, a local cable company, or a person's employer). Accounts are identified by the bank's routing number and the account number within that bank. BACS Payment Schemes Limited in United Kingdom is the equivalent to the ACH network in the United States.

Electronic money movements are generally performed via an electronic payment network, such as the ACH network, the credit card networks, the automated teller machine (ATM) networks, etc. Financial institutions typically settle inter-institution money movements at the end of the business day, which is known as the net settlement system. In the net settlement system, the inter-institution transactions during the business day are accumulated. At the end of the business day, the accounts of the institutions are adjusted on a net basis. In particular, the settlement process for a credit card transaction is not instantaneous: the transaction may not appear on the credit card holder's statement or online account activity for one to two business days, and it can take up to three business days for funds to be deposited in the account of the merchant who receives the credit card payment from the credit card holder for goods sold or service rendered.

The selection for business day convention determines how non-business days are treated. The conventions generally includes “no adjustment” convention where cash flows that fall on a non-business day are assumed to be distributed on the actual day, “previous” convention where cash flows that fall on a non-business day are assumed to be distributed on the previous business day, “following” convention where cash flows that fall on a non-business day are assumed to be distributed on the following business day, among other conventions known to those skilled in the art.

Embodiments of the invention provide an instant payment method/system by extending conventional payment networks that typically settle payment transactions overnight, if not longer. In one or more embodiments of the invention, the instant payment transaction involves asynchronous money movements in a multiple-clearing-accounts configuration. In one or more embodiments, the asynchronous money movements are controlled by a finite state machine (FSM). In particular, the instant payment method/system supports instant money movement between financial accounts of different types (e.g., credit accounts, checking accounts, etc.) that may exist at different financial institutions. For example, instant money movement may be from a parent's checking account to a child's pre-paid debit card. In another example, instant money movement may instantly “store value” on a mobile wallet, where funds stored therein may then be used subsequently for person to person or consumer to business funds transfers or payments. Throughout this disclosure, the terms “instant payment” and “instant money movement” may be used interchangeably depending on the context.

In one or more embodiments, the instant money movement is based on obtaining an assurance (referred to as authorization confirmation) that the source of funds for the instant money movement exists and the funds are reserved for the purpose of instant settlement. For example, when a credit card account is the source of funds, that assurance is obtained via a credit card authorization hold. In another example, when a checking account is the source of funds, that assurance is obtained by a successful intra-account on-line transfer within a financial institution where the checking account is held. Specifically, the intra-account on-line transfer is performed using the checking account as the source account and a “clearing account” as the destination account. In one or more embodiments, the clearing account is a bank account at the same financial institution of the checking account and is controlled (i.e., owned and/or otherwise managed) by a third party service provider (referred to as the instant payment service provider) of the instant money movement.

In one or more embodiments, the instant money movement employs payment risk mitigation measures, which may deny instant settlement on specific transactions, but still clearing the amount from the payer's account into a bookkeeping account (e.g., a stored balance account) on behalf of the payee for the purpose of subsequent settlement of funds when the risk has been mitigated. In one or more embodiments, the payee is allowed to redirect any available funds in his/her stored balance account to a destination other than the original destination of the instant payment. In one or more embodiments, the instant money movement employs payment exception handling mechanisms for chargebacks and returns.

In one or more embodiments, a payer is an individual or organization that acts to make an electronic payment/send-funds to a payee. A payee is an individual or organization that is authorized to receive electronic payments from a payer. A payment account is an account at a financial institution that is maintained on behalf of a payer or payee. The payment account holds a funds-balance that can be used for making electronic payments and/or receiving electronic payments. The funds-balance could be a credit-balance (e.g., credit card account), bank-balance (e.g., bank checking account accessed via a debit-card), stored balance (e.g., backing a gift-card, backing a reloadable-debit-card, or a stored balance at a financial institution that supports electronic payment transactions).

In one or more embodiments, a payment method is a means for accessing a payment account. Examples include the credit card for accessing a credit account, the paper check or the debit-card for accessing a checking account, and the gift card for accessing a stored balance account. Payment methods do not always involve payment cards. In many cases, only the payer's payment account number and/or account-holder's-user-identity is required to initiate an electronic payment.

In one or more embodiments, a payment network supports one or more payment methods by enabling and effecting money movement between a payment account (that is associated with that payment method) and a clearing account. Typically there is a distinct payment network for each payment method. Each payment network supports APIs (interfaces) used to reserve funds, check balances, and move money. These APIs are often distinct and specialized to the individual payment network, but many follow the general guidance of the ISO8583 specifications known to those skilled in the art.

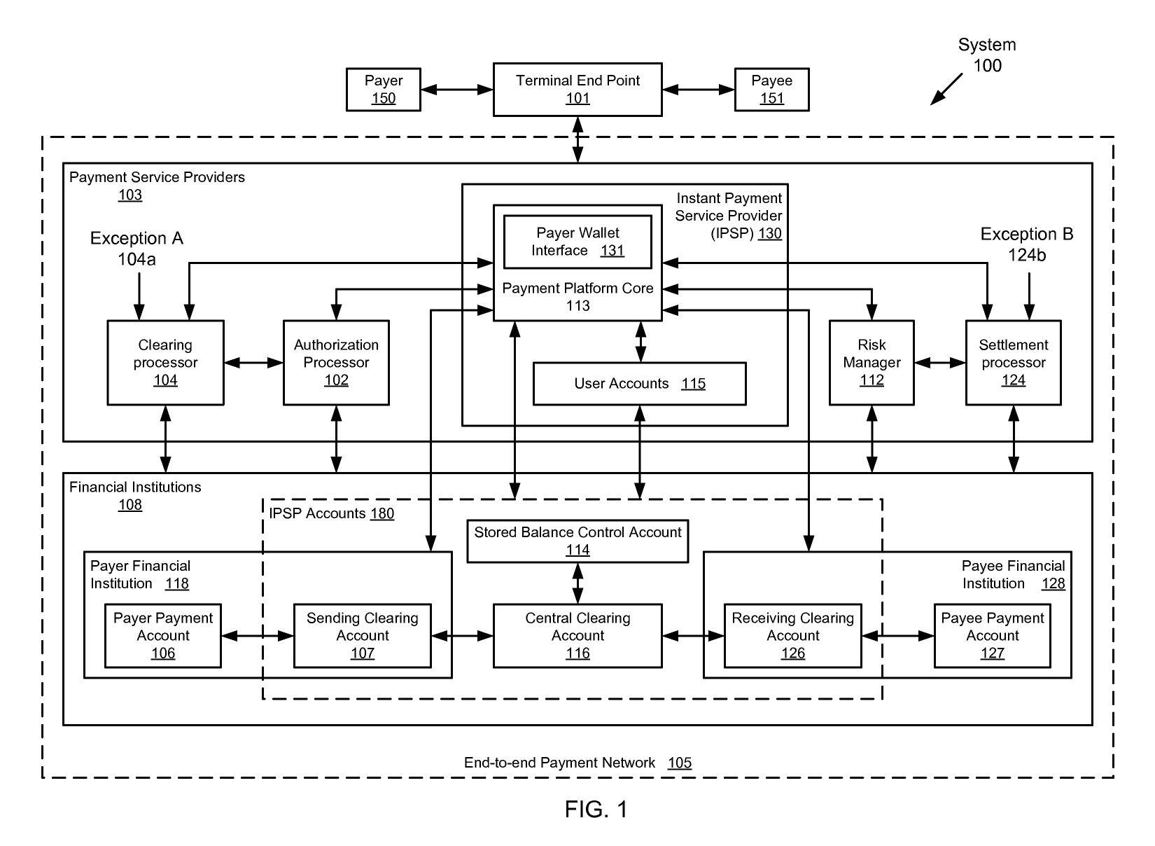

FIG. 1 depicts a schematic block diagram of a system (100) in accordance with one or more embodiments of the invention. In one or more embodiments of the invention, one or more of the modules and elements shown in FIG. 1 may be omitted, repeated, and/or substituted. Accordingly, embodiments of the invention should not be considered limited to the specific arrangements of modules shown in FIG. 1.

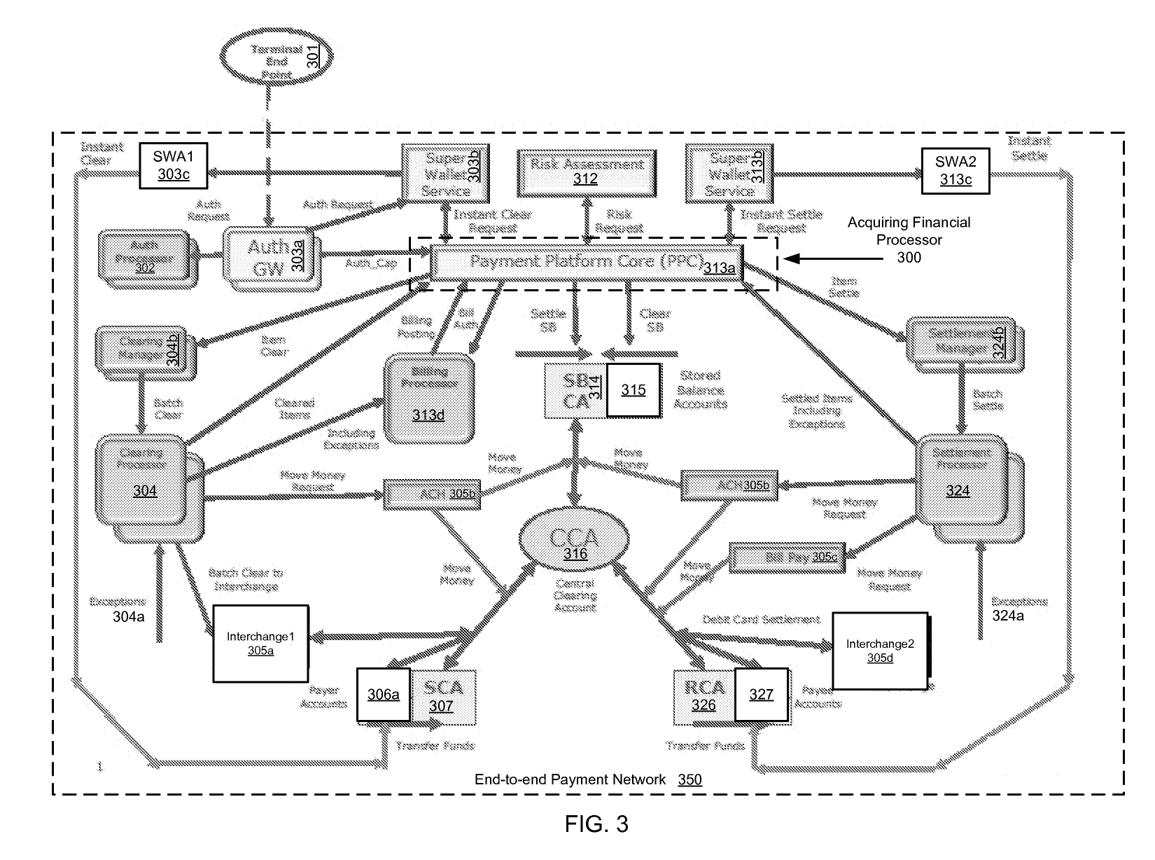

As shown in FIG. 1, the system (100) includes a payer (150), a payee (151), a terminal end point (101), and an end-to-end payment network (105) having payment service providers (103) and financial institutions (108). In one or more embodiments, the payment service providers (103) include an instant payment service provider (IPSP) (130) having a payment platform core (113) and user accounts (115), a clearing processor (104), a settlement processor (124), an authorization processor (102), and a risk manager (112). In one or more embodiments, the IPSP (130) is an Acquiring Financial Processor described in reference to the example shown in FIG. 3 below.

In one or more embodiments, the payment platform core (113), the clearing processor (104), the settlement processor (124), the authorization processor (102), and the risk manager (112) include software applications and modules executing on computer server(s) (not shown) and are operated or otherwise controlled by the IPSP (130), a clearing service provider (not shown), a settlement service provider (not shown), an authorization service provider (not shown), and a risk service provider (not shown), respectively. In particular, the IPSP (130), clearing service provider, settlement service provider, authorization service provider, and risk service provider are business entities involved in money movements using the end-to-end payment network (105) In one or more embodiments, these business entities may use different payment networks that are unrelated to each other. In such embodiments, the payment platform core (113) effects the end-to-end money movement from payee to payer based on the other payment service providers' ability to connect directly or indirectly to all needed payment networks. Throughout this disclosure depending on the context, the terms “clearing processor,” “settlement processor,” “authorization processor,” and “risk manager” may be used interchangeably with their counterparts in the terms “clearing service provider,” “settlement service provider,” “authorization service provider,” and “risk service provider.”

In one or more embodiments, the end-to-end payment network (105) includes one or more of the ACH network, the automated teller machine (ATM) network, a credit card network, etc. for moving funds among financial institutions (e.g., a deposit account financial institution, an issuing bank of a credit card, etc.) and various financial accounts (e.g., a deposit account, a credit card account, etc.) therein. For example, a payment network may be used to support money movement from the payer (150) to a central clearing account (CCA) (116), with a possibly different payment network used to support money movement from the CCA (116) to the payee (151). These financial institutions include a payer financial institution (118) and a payee financial institution (128). The various financial accounts include a payer's payment account (106) controlled by the payer (150), a payee's payment account (127) controlled by the payee (151), and IPSP accounts (180) controlled by the IPSP (130). In one or more embodiments, the IPSP accounts (180) include a sending clearing account (SCA) (107), a receiving clearing account (RCA) (126), a stored balance control account (114), and a central clearing account (CCA) (116) that are configured to extend the money movement mechanisms of the ACH network, the automated teller machine (ATM) network, the credit card network, etc. for instant clearing and settlement. Further, one or more of the aforementioned service providers and financial institutions may participate in one or more of the ACH network, the automated teller machine (ATM) network, the credit card network, etc. as member(s). In one or more embodiments, the IPSP (130) is not a member of any of these ACH network, automated teller machine (ATM) network, credit card network, or other conventional payment network and orchestrates money movement purely based on alliances with other third party entities that are network members. Generally, a member of a network in the end-to-end payment network (105) is a bank, not a service provider. Banks typically are not payment service providers, but will form alliances with third party payment service providers, and then (optionally) resell those payment services to their own customers. In addition, and quite often, the payment service providers will form alliances with independent sales organizations (ISOs) that will sell payment services under their own label (e.g., to merchants). In one or more embodiments, the IPSP (130) forms alliances with banks to access one or more network in the end-to-end payment network (105) via bank-affiliated payment service providers. Accordingly, both the banks and the affiliated payment service providers act as silent participants in the selling and payment processing activities while. the merchant and consumer (i.e., payee and payer) appear to be served directly by IPSP (130).

In one or more embodiments, the payer financial institution (118) has a payer's payment account (e.g., the payer's payment account (106)) controlled by the payer (150). In one or more embodiments, the payee financial institution (128) is external to the payer financial institution (118) and has a payee's payment account (e.g., the payee's payment account (127)) controlled by the payee (151), and the receiving clearing account (126) controlled by the IPSP (130).

In one or more embodiments, the payment platform core (113) receives a request from the payer (150) to pay the payee (151). For example, the request may be received from the terminal end point (101) and includes a payer account ID (e.g., an account number) identifying, directly or indirectly the payer's payment account (106) held at the payer financial institution (118), a payee account ID (e.g., an account number) identifying, directly or indirectly the payee's payment account (127) held at the payee financial institution (128), and a payment amount. Generally, the terminal end point (101) is a device for requesting the end-to-end payment network (105) to perform a payment. In one or more embodiments, the terminal end point (101) is a point of sale (POS) and may be (i) a traditional payments terminal at a retail location (e.g., where the payer (150) swipes his/her payment card), (ii) a mobile payments terminal (e.g., a mobile phone with installed payment application, optionally equipped with a magnetic payment card reader), or (iii) a commerce web site (e.g., configured with a “Shopping Cart” that can accept purchase/payment requests).

In response to the request from the payer (150) to pay the payee (151), the payment platform core (113) receives, based on the payer account ID, a reservation confirmation that the payment amount is reserved from the payer's payment account (106). In one or more embodiments, the payer's payment account (106) is a deposit account, and the reservation confirmation is based on an instant clearing process, described later, that performs an intra-account on-line transfer within the payer financial institution (118). In one or more embodiments, the payer's payment account (106) is a credit card/debit card account, and the reservation confirmation is based on an authorization hold placed on the credit card/debit card account.

Further, the payment platform core (113) retrieves, based on the payee account ID, an RCA ID identifying the receiving clearing account (126) held at the payee financial institution (128) and controlled by the IPSP (130). Generally, for each financial institution where the payee (151) may designate as destination for the payment, the IPSP (130) may hold a separate receiving clearing account.

Based on the RCA ID, the payment platform core (113) initiates, in response to the reservation confirmation, a settlement process as part of the payee-side payment transaction. In one or more embodiments, once initiated by the payment processor core (113), at least a portion of the settlement process is performed by the settlement processor (124) according to business agreements established among the IPSP (130), the settlement service provider operating the settlement processor (124), and business entities in the end-to-end payment network (105). In one or more embodiments, the settlement process includes (i) transferring the payment amount from the receiving clearing account (126) to the payee's payment account (127) using on-demand and instant electronic funds transfer (EFT) (referred to as the payee EFT) capability of the payee financial institution (128), and (ii) debiting, in response to the transferring, the payment amount from the central clearing account (116) to reimburse the receiving clearing account (126).

In one or more embodiments, the payer's payment account (106) is debited to reimburse the central clearing account (116) held at a sponsoring bank (not shown) and controlled by the IPSP (130). In other words, the receiving clearing account (126) is reimbursed from the central clearing account (116), and the central clearing account (116) is reimbursed, directly or indirectly, from the payer's payment account (106). In particular, the sponsoring bank is a member of the end-to-end payment network (105), is accountable to the end-to-end payment network (105) for the integrity of the payment transactions, and delegates the effecting of money movement, by contract, to one or more payment service provider. Each such payment service provider nominally maintains a central clearing account (e.g., the central clearing account (116)) at the Sponsoring Bank.

In one or more embodiments, the payment amount is transferred from the receiving clearing account (126) to the payee's payment account (127) within a pre-determined time period from receiving the request by the IPSP (130), more specifically by the payment platform core (113). This pre-determined time period is typically less than the conventional settlement time period and such expedient settlement is referred to as the instant settlement. For example, the pre-determined period may be a single business day as defined by the business day conventions known to one skilled in the art. Different business day conventions may be selected in different embodiments of instant settlement. For example, when “no adjustment” convention is selected, the payment amount is transferred from the receiving clearing account (126) to the payee's payment account (127) within the same actual day (including any business holiday) of receiving the request by the IPSP (130). In another example, the pre-determined time period may be fixed time delay (e.g., an hour, five minutes, etc.) starting from the moment the request is received. In yet another example, the pre-determined time period may consist of only electronic processing delay through the payment service providers (103) and the end-to-end payment network (105). Accordingly, the payee (151) receives, and is able to access the payment amount in the payee's payment account (127) within a single business day, an hour, five minutes, or only the aforementioned electronic processing delay from receiving the request by the IPSP (130). The term “access” refers to viewing account balance, withdrawing/transferring funds, earning interests, or other ways to utilize the payment amount.

In one or more embodiments, the payment platform core (113) is configured to perform instant payment, which may include just the instant settlement, or both the instant settlement and instant clearing. Specifically functionality of the payment platform core (113) and details of the instant payment, instant settlement, and instant clearing are described below.

In one or more embodiments, in response to the request from the payer (150) to pay the payee (151), the payment platform core (113) determines whether the payer's payment account (106) is a deposit account based on the payer account ID. If the determination is yes, the aforementioned reservation confirmation is based on a clearing process that transfers the payment amount from the deposit account (i.e., the payer's payment account (106)) to the sending clearing account (107). To complete the transfer, the payment platform core (113) first retrieves an SCA ID identifying the sending clearing account (107) that is held at the payer financial institution (118) and controlled by the IPSP (130). Generally, for each financial institution where the payer (150) may designate as source for the payment, the IPSP (130) may hold a separate sending clearing account.

Based on the SCA ID, the payment platform core (113) initiates a clearing process as part of the payer-side payment transaction. In one or more embodiments, the payment processor core (113) may initiate the clearing process directly or via the authorization processor (102). In one or more embodiments, once initiated by the payment processor core (113), at least a portion of the clearing process is performed by the clearing processor (104) according to business agreements established among the IPSP (130), the clearing service provider operating the clearing processor (104), and business entities in the end-to-end payment network (105). In one or more embodiments, the clearing process includes (i) transferring the payment amount from the deposit account (i.e., the payer's payment account (106)) to the sending clearing account (107) using EFT (referred to as the payer EFT) capability of the payer financial institution (118), and (ii) reimbursing the central clearing account (116) from the sending clearing account (107), e.g., using the ACH network. In other words, the central clearing account (116) is reimbursed indirectly from the payer's payment account (106) via the sending clearing account (107).

In one or more embodiments, the payment amount is transferred from the deposit account (i.e., the payer's payment account (106)) to the sending clearing account (107) within a pre-determined time period of receiving the request by the IPSP (130), more specifically by the payment platform core (113). This pre-determined time period is typically less than the conventional clearing time period and such expedient clearing is referred to as the instant clearing. For example, the pre-determined period may be a single business day as defined by the business day conventions known to one skilled in the art. Different business day convention may be selected in different embodiments of instant settlement. For example, when “no adjustment” convention is selected, the payment amount is transferred from the payer's payment account (106) to the sending clearing account (107) within the same actual day (including any business holiday) of receiving the request by the IPSP (130). In another example, the pre-determined time period may be fixed time delay (e.g., an hour, five minutes, etc.) starting from the moment the request is received. In yet another example, the pre-determined time period may consist of only electronic processing delay through the payment service providers (103) and the end-to-end payment network (105). Accordingly, the reservation confirmation is generated within a single business day, an hour, five minutes, or only the aforementioned electronic processing delay from receiving the request by the IPSP (130).

In one or more embodiments, in response to the request from the payer (150) to pay the payee (151), the payment platform core (113) determines whether the payer's payment account (106) is a credit card account. For example, the payer financial institution (118) may be a credit card issuing bank and the payer's payment account (106) may be a credit card account. In such embodiments, the money movement bypasses (i.e., does not require) the sending clearing account (107) that is to be omitted from FIG. 1. If it is determined that the payer's payment account (106) is a credit card account, the payment platform core (113) sends an authorization request to the authorization processor (102) (e.g., operated by a credit card authorization service provider) to block (i.e., place an authorization hold) of the payment amount from the credit card account (i.e., the payer's payment account (106)). Accordingly, the reservation confirmation is based on receiving an authorization code from the authorization processor (102) confirming that the payment amount has been blocked from the credit card account.

Based on the authorization code, the payment platform core (113) initiates a clearing process as part of the payer-side payment transaction. In one or more embodiments, the payment processor core (113) may initiate the clearing process directly or via the authorization processor (102). In one or more embodiments, once initiated by the payment processor core (113), at least a portion of the clearing process is performed by the clearing processor (104) according to business agreements established among the IPSP (130), the clearing service provider operating the clearing processor (104), and business entities in the end-to-end payment network (105). In one or more embodiments, the clearing process includes transferring the payment amount from the credit card account (i.e., the payer's payment account (106)) to the central clearing account (116), such that the settlement process may reimburse the receiving clearing account (126) from the central clearing account (116).

In one or more embodiments, the payment platform core (113) is configured to perform the clearing process and the settlement process, described above, using at least a clearing finite state machine (FSM) and a settlement FSM, respectively that are executing on a computer processor (not shown). In one or more embodiments, the clearing FSM and the settlement FSM are coupled based on the aforementioned reservation confirmation.

In one or more embodiments, the payment platform core (113) is further configured to credit, in response at least to the reservation confirmation, the payment amount to a bookkeeping account (e.g., one of the user accounts (115)) maintained by the (IPSP) for the payee (151). For example, the bookkeeping account may be set up when the payee (151) initially registers to receive instant payment service from the IPSP (130). In particular, the receiving clearing account (126) is dedicated for use by the IPSP (130) and is not accessible to the payer (150) or the payee (151). For example, the receiving clearing account (126) may be an aggregate account with its balance shared for all payees at the payee's financial institution. The bookkeeping account is not a real financial account in the sense that the payee (151) can not access any funds other than viewing the balance. Specifically, the bookkeeping account allows the payee (151) to view a balance reflecting the funds that have been reserved from the payer's payment account (106), thus indicating a status of the payment from the payer (150). When the payment amount is credited to the payee's payment account (127) upon settlement, the payment amount is also debited from the bookkeeping account. Typically, the bookkeeping account only shows a balance for a short duration when the instant payment is in progress or for an overnight period when a sweep process is performed in lieu of the instant payment. Whenever the balance remains in the bookkeeping account for any longer duration (e.g., marked as “pending” or “sweep”), the bookkeeping account is backed by a real financial account and is referred to as a stored balance financial account (e.g., one of the user accounts (115)). Throughout this disclosure, the terms “bookkeeping account” and “stored balance financial account” may be used interchangeably depending on the context.

In one or more embodiments, the stored balance financial account has many of the same general payment capabilities as a transactional account at a Bank. Although, checks are not allowed to be written against the stored balance financial account, the payee (151) may make debit card transactions against the stored balance financial account, designate directly or indirectly the stored balance financial account as a source of payment to others, designate the stored balance financial account as a destination of payment from others, hold funds in a pending status while awaiting risk mitigation. Furthermore, the funds that back the amount in the stored balance financial account can be confirmed-reserved in the Payers Payment Account, or be in the sending clearing account (107), the central clearing account (116), the stored balance control account (114), or other intermediate accounts. In other words, the payee (151) is informed of the status of the funds without knowing the actual account holding the funds at any given time. In one or more embodiments, the payment platform core (113) is configured to track the actual account holding the funds at any given time using the aforementioned FSMs.

In one or more embodiments, the IPSP accounts (108) includes a stored balance control account (114) that is a clearing-like account holding the funds in aggregate for all of the user accounts (115). In effect, the aforementioned stored balance financial account is one of the “buckets” that partition the funds in the stored balance control account (114). In other words, the stored balance control account (114) is a “Bank Asset” account for the IPSP (130), whereas the aforementioned stored balance financial account is a ledger “Liability” account for the IPSP (130). In one or more embodiments, the stored balance financial account can be used as either a payer payment account (106), or as a payee payment account (127), including simultaneously serving both roles. All discussion involving clearing from payer payment account (106), and settlement to payee payment account (127) also apply to the stored balance financial account acting as a deposit account for the purpose of payment source or destination of funds.

From time to time, the payment platform core (113) may receive a failure indication (e.g., exception B (124b)) of the settlement process, for example due to a computer problem or a network outage. In such scenario, the instant payment, more specifically the transferring and debiting of the settlement process can not be performed. Instead, the payment platform core (113) changes a status of the amount of payment in the bookkeeping account from a transit status to a sweep status, in which case the payment amount may be transferred from the payer's payment account (106) to the payee's payment account (127) via an overnight sweep process, which uses, for example, the ACH network to credit the payee's payment account (127) instead of the EFT process of the payee financial institution (128).

From time to time, the payment platform core (113) may receive a risk indication (e.g., exception B (124b)) of the settlement process, for example due to a credit issue of the payee (151) identified by the risk manager (112). In such scenario, the instant payment, more specifically the transferring and debiting of the settlement process can not be performed. Instead, the payment platform core (113) changes a status of the amount of payment in the bookkeeping account from a transit status to a pending status, and credit the payment amount to the aforementioned stored balance financial account. When a risk resolution indication is received, the payment platform core (113) may then transfer the payment amount from the stored balance financial account to the payee's payment account (127). In one or more embodiments, a bookkeeping account tracks the status of funds-transfer from the payer payment account (106) to the payee payment account (127) through the use of possibly several intermediate accounts, such as the sending clearing account (107), central clearing account (116), stored balance control account (114), and receiving clearing account (126). Whenever the funds reside in the stored balance control account (114), the bookkeeping account is viewed and used as a stored balance financial account.

From time to time, the payment platform core (113) may receive an input from the payee (151) to store settlement funds in the payee's stored balance financial account. In such scenario, the instant payment, more specifically the transferring and debiting step(s) of the settlement process is performed differently. Instead of the transferring and debiting of the settlement process described above, the payment platform core (113) credit the payment amount to the stored balance financial account and moves the funds into the stored balance control account (114).

In one or more embodiments, the payment platform core (113) is further configured to receive, in response to completing the settlement process, a service fee from the payee (151). In the scenario when the payee (151) requests to utilize the bookkeeping account as the real financial account, the service fee is discounted in response to holding the payment amount in the stored balance financial account in lieu of transferring to the payee's payment account (127). Those skilled in the art, with the benefit of this disclosure will appreciate that other embodiments of billing of service fees may be devised.

In one or more embodiments, the payment platform core (113) includes the payer wallet interface (131) that is an API (application programming interface) abstraction that makes payment accounts “act” like a wallet, and supports multiple payment methods including credit card, check, stored balance. An example of the payer wallet interface (131) is shown in FIG. 3 as the Super Wallet Service (303b), which is used by the authorization gateway (Auth GW) (303a) to achieve instant clearing from either the payer payment account (106), or the aforementioned stored balance financial account,.

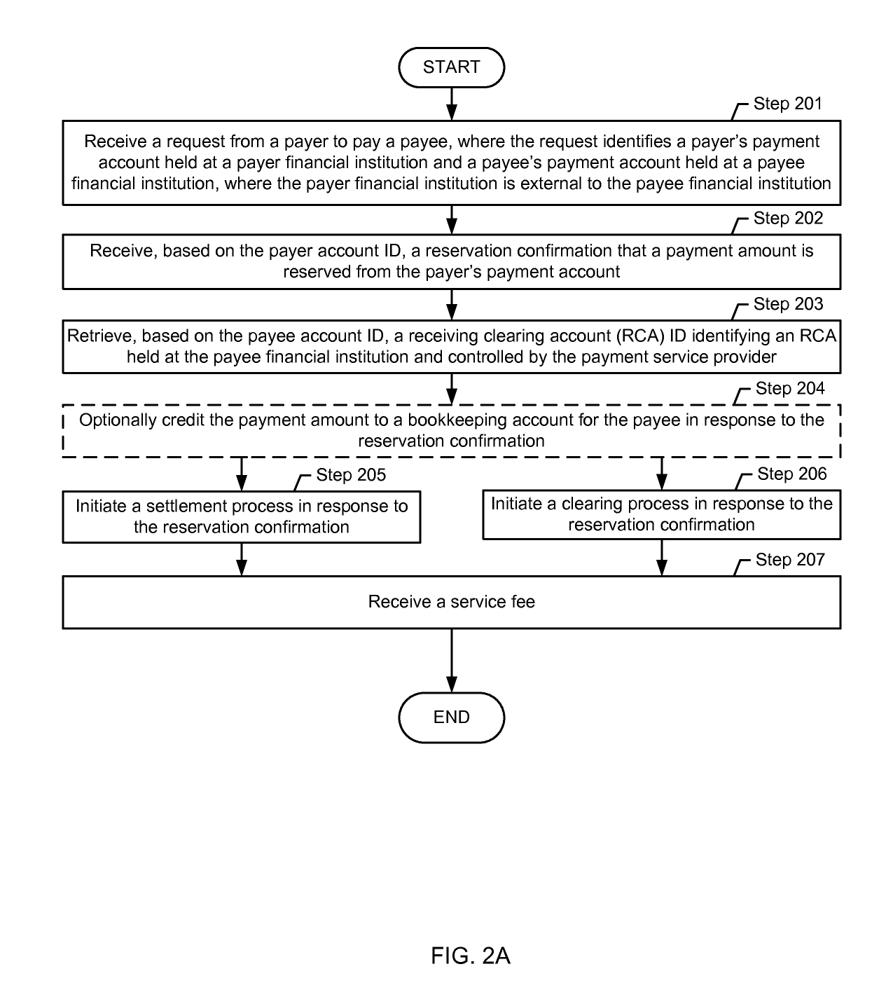

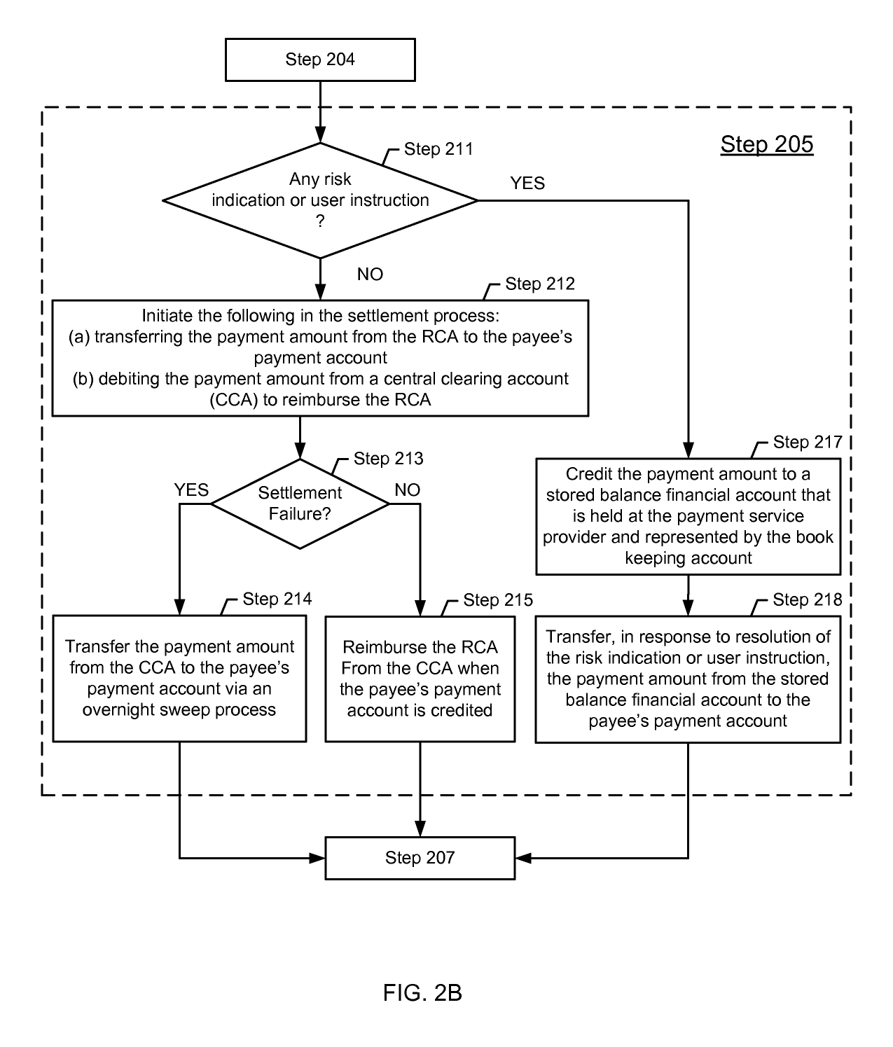

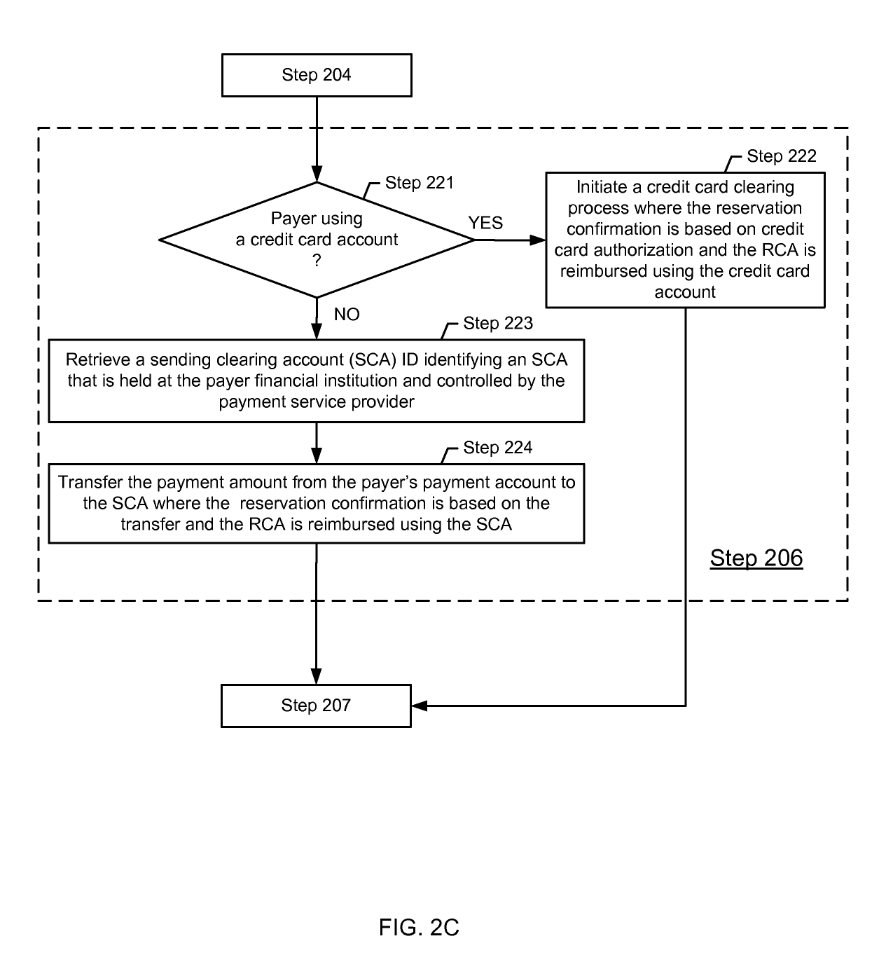

FIG. 2A depicts a flowchart of a method in accordance with one or more embodiments of the invention. In one or more embodiments of the invention, one or more of the steps shown in FIG. 2A may be omitted, repeated, and/or performed in a different order. Accordingly, embodiments of the invention should not be considered limited to the specific arrangements of steps shown in FIG. 2A. In one or more embodiments, the method described in reference to FIG. 2A may be practiced using the system (100).

Initially in Step 201, a request is received from a payer to pay a payee. In one or more embodiments, the request includes a payer account ID identifying a payer's payment account held at a payer financial institution and a payee account ID identifying a payee's payment account held at a payee financial institution. In addition, the request typically also includes a payment amount. In one or more embodiments, the payer financial institution is external to the payee financial institution. In other words, the payer financial institution and the payee financial institution are separate business entities. In one or more embodiments, the payer's payment account and the payee's payment account are different types of accounts, such as credit card account, debit card account, checking account, etc.

In Step 202, a reservation confirmation is received based on the payer account ID. Specifically, the reservation confirmation confirms that the payment amount is reserved from the payer's payment account. As noted above, the payer's payment account may be a credit card account, debit card account, checking account, etc. where the reservation confirmation may be in different forms. Examples of different forms of the reservation confirmation are described in reference to FIG. 2C below. In one or more embodiments, upon receipt of the reservation confirmation (i.e., in real time), the payment amount is credited to a bookkeeping account held at a payment service provider for the payee. In particular, the crediting occurs before any attempt is made to transferring the payment amount to the payee's payment account.

In Step 203, a receiving clearing account (RCA) ID is retrieved based on the payee account ID. Specifically, the RCA ID identifies an RCA held at the payee financial institution and controlled by a payment service provider. In one or more embodiments, the payment service provider orchestrates various money movements to complete the instant payment transaction for the payer and payee. In one or more embodiments, the instant payment transaction may include instant settlement without instant clearing, or include both instant settlement and instant clearing. Examples of the payment service provider and the instant payment transaction performed thereby are described in reference to FIGS. 1 and 3.

In Step 204, in response at least to the reservation confirmation, the payment amount is optionally credited to a bookkeeping account maintained by the payment service provider for the payee. In one or more embodiments, the payment amount is debited from the bookkeeping account when the payment amount is credited to the payee's payment account upon settlement. As described in FIG. 1 above, the RCA is not accessible by the payee, and the bookkeeping account is accessible by the payee allowing the payee to keep track of a status of the payment. Examples of the bookkeeping account are described in reference to FIGS. 1 and 3.

In one or more embodiments, in response at least to the reservation confirmation, a settlement process and a clearing process are initiated in Step 205 and Step 206, respectively. In one or more embodiments, the settlement process and the clearing process are initiated and/or performed asynchronously. Said in other words, clearing is decoupled from settlement, and therefore any one of the clearing methods (e.g., use of SCA, debit card clearing, credit card clearing, ACH, stored balance account debit, etc.) and payer payment methods can be coupled to any one of the settlement methods (e.g., via RCA, ACH, paper check, stored balance account credit, etc.) for any given request to perform a payment.

In one or more embodiments, the clearing process and the settlement process are performed using at least a clearing finite state machine (FSM) and a settlement FSM that are coupled based on the reservation confirmation. Details of the settlement process and the clearing process are described in reference to FIGS. 2B and 2C, respectively.

In Step 207, upon successful completion of the settlement process and the clearing process, a service fee is received by the payment service provider. In one or more embodiments, the service fee is received from the payee. For example, the service fee may be deducted from the payment amount that is transferred into the payee's payment account upon settlement.

FIG. 2B depicts a flowchart of a method in accordance with one or more embodiments of the invention. Specifically, FIG. 2B shows additional details of the Step 205 of FIG. 2A above. In one or more embodiments of the invention, one or more of the steps shown in FIG. 2B may be omitted, repeated, and/or performed in a different order. Accordingly, embodiments of the invention should not be considered limited to the specific arrangements of steps shown in FIG. 2B. In one or more embodiments, the method described in reference to FIG. 2B may be practiced using the system (100).

In Step 211, a determination is made regarding whether any risk indication or user instruction relating to the settlement process is received or pending. For example, the risk indication may be received from a risk assessment service provider that indicates it risky to immediately settle the payment transaction, such as due to a credit issue of the payee or possibility of fraudulent activities. In other words, risk may exist to immediately release the payment amount from the control of the payment service provider. In another example, the user instruction may be received from the payee to divert the payment amount from the payee's payment account to a stored balance financial account maintained by the payment service provider for the payee. If the determination in Step 211 is no, the method proceeds to Step 212. If the determination is yes, the method proceeds to Step 217.

In Step 212, the transfer of the payment amount from the RCA to the payee's payment account is initiated. In one or more embodiments, the transfer is completed using an electronic funds transfer (EFT) (referred to as EFT) capability of the payee's financial institution. Further, the debit of the payment amount from a central clearing account (CCA) is initiated to reimburse the RCA. In one or more embodiments, the debit is initiated in response to the transferring. In one or more embodiments, the debit is initiated asynchronously with respect to the transferring. In one or more embodiments, the transfer is completed within a pre-determined time period from receiving the request by the payment service provider (shown in Step 201 of FIG. 2A). In one or more embodiments, this pre-determined time period is typically less than the conventional settlement time period and such expedient settlement is referred to as the instant settlement. As noted above in reference to FIG. 1, the pre-determined period may be a single business day, an hour, five minutes, any other time period, or only the electronic processing delay from receiving the request by the payment service provider. Accordingly, the payee receives, and is able to access (e.g., view account balance, withdraw/transfer funds, earn interests, or other ways to utilize the payment amount) the payment amount in the payee's payment account expediently.

In one or more embodiments, the RCA is reimbursed from the payer's payment account via the central clearing account (CCA) held at a sponsoring bank and controlled by the payment service provider. In such embodiments, the CCA is reimbursed from the payer's payment account or a sending clearing account (SCA), or stored balance control account

In Step 213, a determination is made regarding whether the settlement process encounters any failure. In other words, it is determined whether the transfer and the debit initiated in Step 212 above may have failed. For example, the settlement failure may be due to a computer system failure, a computer network outage, or any other hardware/software/equipment failure. If the determination is yes, the method proceeds to Step 214 where the payment amount is transferred from the CCA to the payee's payment account via an overnight sweep process. Further, and prior to the initiation of the sweep process, a status of the amount of payment in the bookkeeping account is changed from a transit status to a sweep status to notify the payee of the action as a result of the settlement failure.

If the determination in Step 213 is no, the method proceeds to Step 215 where the settlement process is completed. In particular, the RCA is reimbursed and the bookkeeping account is debited when the payee's payment account is credited upon settlement. If the payee's payment account credit initiated in Step 212 completes with no failure, the only action in Step 215 is to reimburse the RCA from the CCA, and adjust the bookkeeping account accordingly.

Returning to the discussion of Step 211, if the determination in Step 211 is yes, the method proceeds to Step 217. Specifically, if the aforementioned risk indication or user instruction is received, Step 217 is performed where the payment amount is credited to a stored balance financial account that is held at the payment service provider. Further, funds are moved to the stored balance control account, which is presented to the payee as the balance in the stored balance financial account. In doing so, the payment amount remains in the control of the payment service provider in case the risk indication is pending. In another case, the payee may instruct to hold the payment amount in the stored balance financial account in lieu of transferring to the payee's payment account.

In response to holding the payment amount under control of the payment service provider, a status of the amount of payment in the bookkeeping account is changed from a transit status to a pending status to inform the payee regarding the payment status

In Step 218, in response to resolution of the risk indication or further user instruction, the payment amount is transferred from the stored balance financial account to the payee's payment account via the CCA.

Upon completion of Step 214, Step 215, or Step 218, the method proceeds to Step 207 shown in FIG. 2A above.

FIG. 2C depicts a flowchart of a method in accordance with one or more embodiments of the invention. Specifically, FIG. 2C shows additional details of the Step 206 of FIG. 2A above. In one or more embodiments of the invention, one or more of the steps shown in FIG. 2C may be omitted, repeated, and/or performed in a different order. Accordingly, embodiments of the invention should not be considered limited to the specific arrangements of steps shown in FIG. 2C. In one or more embodiments, the method described in reference to FIG. 2C may be practiced using the system (100).

In Step 221, a determination is made regarding whether the payer is using a credit card for the payment. If the determination is yes, the method proceeds to Step 222. If the determination is in Step 221 is no, for example if the payer is using a deposit account for source of the payment, the method proceeds to Step 223.

In Step 222, in response to identifying the payer's payment account as a credit card account based on the payer account ID, a credit card clearing process is initiated. Specifically, an authorization request is sent to a credit card authorization service provider to block (i.e., via an authorization hold) the payment amount from the credit card account. Accordingly, the reservation confirmation is based on receiving an authorization code from the credit card authorization processor confirming that the payment amount has been blocked from the credit card account. In one or more embodiments, no sending clearing account is used in the credit card clearing process and the RCA is reimbursed using the credit card account.] In one or more embodiments, the payment amount is first transferred from the credit card account to a central clearing account (CCA) that is held at a sponsoring bank and controlled by the payment service provider. Subsequently, the RCA is then reimbursed from the CCA.

In Step 223, in response to identifying the payer's payment account as a deposit account based on the payer account ID, a sending clearing account (SCA) ID is retrieved that identifies an SCA that is held at the payer financial institution and controlled by the payment service provider.

In Step 224, the payment amount is transferred from the deposit account to the SCA using an EFT (referred to as payer EFT) capability of the payer's financial institution. Upon completion of transferring the payment amount from the deposit account to the SCA, the reservation confirmation is generated accordingly. In one or more embodiments, the RCA is reimbursed from the SCA. In one or more embodiments, the payment amount is first transferred from the deposit account to a central clearing account (CCA) that is held at a sponsoring bank and controlled by the payment service provider. Subsequently, the RCA is then reimbursed from the CCA.

Upon completion of Step 222 or Step 224, the method proceeds to Step 207 shown in FIG. 2A above.

FIG. 3 shows an application example in accordance with one or more embodiments of the invention. This application example may be practiced using the system (100) of FIG. 1 and based on the method described with respect to FIGS. 2A, 2B, and 2C above.

The example shown in FIG. 3 describes a method of operation of a payments platform core (PPC) (313a) used by an Acquiring Financial Processor (300). In particular, real time payment messages are used to orchestrate payment/funds-transfer between a payer and a payee who may have their funds resident in different payment accounts at different financial institutions. A payment message is a data-record that is transmitted between different systems/services that are involved in payment-processing. Some of these payment systems/services may be operated by different business-entities, all cooperating to support the fiduciary intent of the payment message. In particular, real time means that actions are effected in a time frame that is only limited by network latency.

As shown in FIG. 3, the terminal end point (301) is essentially the same as the terminal end point (101) shown in FIG. 1 above. As noted above, the terminal end point (301) may be a traditional payments terminal at a retail location, a mobile payments terminal of the payer, a web site enabled with a “Shopping Cart.” The terminal end point (301) captures the intent of a payer to make a payment or to send funds to a payee. The information captured includes, but is not limited to (i) an identifier for the payee that directly or indirectly specifies the payee's payment account (327) to which the funds are to be credited, (ii) an identifier for the payer that directly or indirectly specifies the payer's payment account (306a) from which the funds will be debited, (iii) expiration dates and security codes, as necessary, for the payer's payment account (306a), (iv) the amount of the funds, (v) the currency of the funds-amount, (vi) the date, time, and location of the payment request, and (vii) optionally the name and address information of the payer.

Further as shown in FIG. 3, the end-to-end payment network (350) is an example of the end-to-end payment network (105) shown in FIG. 1 above. In the example shown in FIG. 3, the payer's payment account (306a) and payee's payment account (327) are both deposit accounts, such as a checking account. Various additional components of the end-to-end payment network (350) are described in detail below.

The Super Wallet Service (303b) and Super Wallet Service (313b) are an API abstraction that makes potentially multiple payment accounts “act” like a wallet, and supports stored balance, instant clearing, and instant settlement. The Super Wallet Service (303b) is an example of the payer wallet interface (131) shown in FIG. 1 and implements an API for accessing stored balance funds for “issuing” purposes. For example one of the stored balance accounts (315) may be set up for the payer when the payer subscribes to the instant payment service. The Super Wallet (303b) also implements Least Cost Routing by first seeing if funds are available from stored balance, and if not, routing the request to an external instant clearing source via a Super Wallet Adapter (SWA), such as the SWA1 (303c).

The Super Wallet Adapter (SWA1 (303c) and SWA2 (313c)) implement a Super Wallet API as a facade for a financial institution that supports instant clearing and/or instant settlement via their own API. The SWA therefore adapts a financial institution's proprietary API to the API of the payment platform core (PPC) (313a) for orchestrating instant clearing and instant settlement. The PPC (313a) is an example of the payment platform core (113) shown in FIG. 1 above.

The Acquirer is a financial institution (in any country) that is typically a member of that country's equivalent of the Federal Reserve network (in the US, the Acquirer is a bank), and also typically a member of one or more payment interchange networks (e.g., Visa°, MasterCard°, etc.). The Acquirer “sponsors” a payee to receive electronic payments, and is the financial institution of last resort for recovery of funds should fraudulent money-movement activities occur.

The Acquiring Financial Processor (300) is the coordinator/orchestrator of money movement between a payer's payment account and the payee's payment account. The Acquiring Financial Processor (300) may have relationships with multiple Acquirers. The PPC (313a) provides the money movement/orchestration implementation components for an Acquiring Financial Processor (300). For example, the IPSP (130) may be an Acquiring Financial Processor.

The Acquiring Financial Processor (300) accommodates, directly or indirectly, the authorization, clearing, and settlement protocols of the financial institutions (or their associated payment networks) where the payer's payment account (306a) and the payee's payment account (327) are held. This is usually accomplished by partnering with an authorization processor (302), a clearing processor (304), and a settlement processor (324). In the example shown in FIG. 3, the Acquiring Financial Processor (300) uses a facade pattern to isolate its internal operations from the individual/distinct characteristics of entities in the end-to-end payment network (350), such as the authorization processor (302), clearing processor (304), and settlement processor (324).

The stored balance accounts (SBAs) (315) are payment accounts maintained on behalf of payer(s) or payee(s) by the Acquiring Financial Processor (300). Thus, the stored balance accounts (315) can act as a payer's payment account and/or a payee's payment account, or both. It often exists to expedite the movement of funds from payer to payee, but it is also used to assist the Acquiring Financial Processor (300) in managing risk. The payer and/or payee is aware of the SBA's existence, can view its balance, and can use the stored balance accounts (315) as a source or destination of payment funds. The stored balance accounts (315) are managed by the PPC (313a).

Funds in any one of the stored balance accounts (315) are marked as “Available,” “Pending,” “Sweep,” “Transit,” or “Reserve.”

Funds that are marked as “Available” may be used for any payment purpose, including as a source of funds in a payer role, or as a source of funds to be transferred to the payee's payment account (327) at a different financial institution separate from the Acquiring Financial Processor (300).

Funds that are marked as “Pending” are funds that the Acquiring Financial Processor (300) is holding for risk purposes and may have a TTL (Time-to-Live) indicator, which upon expiry will change the mark from “Pending” to one of the other states (e.g., “Available,” “Sweep,” or “Reserve”)

Funds that are marked as “Sweep” are funds that the Acquiring Financial Processor (300) is planning to sweep from the stored balance accounts (315) to the payee's payment account either instantly, or on a periodic basis. The owner (e.g., a payer or payee) of the Stored Balance Account may on-demand request that “Available” funds be marked as “Sweep” funds.

Funds that are intended for instant settlement to a non-stored balance payment account may be marked as “Sweep” in the event the instant settlement attempt fails for any reason.

Funds that are marked as “Transit” are used for several purposes, such as (i) to reserve Stored Balance Funds for clearing or settlement to some other account, (ii) to serve the purpose of sending clearing account for stored balance funds, or (iii) to serve the purpose of receiving clearing account for stored balance funds.

Funds that are marked as “Reserve” are used for two purposes, which is (i) to protect the Acquiring Financial Processor (300) from chargeback/return losses when there is some suspicion that the payee's non-stored balance payment account will not support a debit due to a chargeback or return, and (ii) to protect the payee from non-sufficient-fund (NSF) charges when there is the possibility that a credit return, billing, chargeback, or ACH Return will incur NSF charges by the payee's financial institution that holds the payee's payment account (306a).

The stored balance control account SBCA (314) is a clearing-like account that holds the funds in aggregate for all of the logical stored balance accounts (315). In effect, the stored balance accounts (315) are the “buckets” that partition the funds in the SBCA (314). The PPC (313a) maintains a “shadow” ledger SBCA for the actual SBCA (314) to support audit-ability requirements.

In the example shown in FIG. 3, the end-to-end payment network (350) supports ACH (305b) for clearing or settling money movement based on bank-to-bank money transfers. Further, the interchange 1 (305a), interchange 2 (305d), billing processor (313d), and bill pay (305c) are additional money-movement implementation mechanisms for clearing and settlement via the end-to-end payment network (350).

The authorization gateway (303a) is the initial recipient of a request to authorize the movement of money from a payer to a payee, and also “captures” the simultaneous/subsequent money-movement request. One of the purposes of the authorization gateway (303a) is to provide a facade abstraction to the terminal end point (301) that creates a common interface to the terminal end point (301) regardless of the payment method.

The authorization processor (302) obtains the authorization from the payer's financial institution that the payer is “good for” the payment.

In the example shown in FIG. 3, the payer clearing process (generally referred to as “clearing”) is the act of moving money out-of the payer's designated payment account (306a) to a designated clearing account. Clearing is considered the first half of the money movement that is orchestrated by PPC (313a). The actual implementation of the payer clearing process, including the technique for moving-money, is payment method and payment network dependent, requiring the support of specific clearing processors, such as the clearing processor (304).

In the example shown in FIG. 3, the instant clearing process is a payer clearing process that instantly moves funds from the payer's payment account (306a) to a sending clearing account (SCA) (307). The instant clearing process is used when the payment system wants to create the appearance of instant-money-movement from a payer to a payee, even when the payer's payment account (306a) is at a different financial institution than the payee's payment account (327).

A clearing account is an account at a financial institution that serves as a bridge-account between a payer's payment account and a payee's payment account, and sometimes via other intermediary clearing accounts. In the example shown in FIG. 3, SCA (307) and CCA (316) are clearing accounts used by the Acquiring Financial Processor (300) to support asynchronous money movement between payer's payment account (306a) and payee's payment account (327). In particular, the CCA (316) is owned/managed by the Acquiring Financial Processor (300) and is a bank account at the one of the aforementioned Acquirers. The SCA (307) and CCA (316) are not owned or visible to the payer or payee.

The SCA (307) is a bank-account co-located at the same financial-institution as the payer's payment account (306a), and has the feature that instant “journaling” money-movement can occur between the payer's payment account (306a) and the SCA (307).

The RCA (326) is a bank-account co-located at the same financial-institution as the payee's payment account (327), and has the feature that instant “journaling” money movement transfer can occur between the payee's payment account (327) and the RCA (326).

The clearing processor (304) moves money from the payer's payment account (306a) and/or SCA (307) to the CCA (316), moves money between the CCA (316) and the stored balance control account (315), and provides transformation services to accommodate the requirements of interchange 1 (305a) and/or other standard money-movement mechanisms such as ACH (305b). The clearing processor (304) supports one or more clearing methods, and is usually batch-oriented.

The clearing manager (304b) provides the facade that implements the API of the PPC (313a) that performs clearing based on each payment transaction (referred to as item-clear). This involves both message transformation, as well as conversion of an item-clear API to a batch-clear API, as necessary, to interface to individual clearing processors, such as the clearing processor (304).

In the example shown in FIG. 3, the payee settlement process (generally referred to as “settlement”) is the act of moving money from a clearing account into the payee's designated payment account (327). Settlement is considered the second half of the money movement that is orchestrated by PPC (313a). The actual implementation of the payee settlement process, including the technique for moving-money, is payment network dependent, requiring the support of specific settlement processors, such as the settlement processor (324).

In the example shown in FIG. 3, the payee instant settlement process is a payee settlement process that instantly moves funds from the receiving clearing account (RCA) (326) to the payee's payment account (327). The payee instant settlement process is used when the payment system wants to create the appearance of instant-money-movement from a payer to a payee, even when the payer's payment account (306a) is at a different financial institution than the payee's payment account (327).

The settlement processor (324) moves money from the CCA (316) to the payee's payment account (327) and/or the RCA (326), moves money between the CCA (316) and the stored balance control account (315), and provides transformation services to accommodate the requirements of outside money movement services (e.g., bill pay (305c)), or standard money-movement methods such as ACH (305b). The settlement processor (324) supports one or more settlement methods, and is usually batch-oriented.

The settlement manager (324b) provides the facade that implements the API of the PPC (313a) that performs settlement based on each payment transaction (referred to as item-settle). This involves both message transformation, as well as conversion of an item-settle API to a batch-settle API, as necessary, to interface to individual settlement processors, such as the settlement processor (324).

In the example shown in FIG. 3, the risk assessment (312) is used to determine how funds that arrive for deposit into a stored balance accounts (315) are marked (e.g., as “Available,” “Pending,” “Sweep,” “Transit,” or “Reserve”).

In the example shown in FIG. 3, the PPC (313a) supports instant settlement to the stored balance accounts (315), whether or not funds are destined to an external account. This assures that the instant settlement will always succeed, even if connection to an external account is broken/delayed (e.g., indicated by exceptions (304a), exceptions (324a)), or if funds are held for risk-purposes.

In the example shown in FIG. 3, participating financial institutions may not have knowledge of each other, may not share a common path for money movement, and may not share common infrastructure components. Further, participating financial institutions may use their existing infrastructure (i.e., software, hardware, account-management features, functions, and methodologies) for moving money.

In the example shown in FIG. 3, clearing accounts represent a relationship between two financial institutions. For example, the SCA (307) represents the relationship between the acquiring financial processor (300) and the payer financial institution; the RCA (326) represents the relationship between the acquiring financial processor (300) and the payee financial institution; and the CCA (316) represents the relationship between the acquiring financial processor (300) and the sponsoring bank, which sponsors the acquiring financial processor (300) to use the inter-bank money movement “rails,” such as the ACH (305b).

In the example shown in FIG. 3, money movements between financial institutions using the SCA (307) are restricted to always using the CCA, such as the CCA (316). Similarly, money movements between financial institutions using the RCA (326) are restricted to always using the CCA, such as the CCA (316). These rules are to prevent loss of trust, which easily causes service-stoppage. In particular, the acquiring financial processor (300) regularly justifies the balances in all of the clearing accounts to their financial-institution partner based on the relationship between the acquiring financial processor (300) and the financial institutions. Further, the acquiring financial processor (300) is acting as an outsourced arm of the sponsoring bank, and the sponsoring bank is monitoring all money movement activity into and out of the CCA (316).

Because the CCA (316) is used as an intermediary, the payer financial institution holding the SCA (307) generally has no knowledge that the acquiring financial processor (300) has a relationship with the payee financial institution regarding the RCA (326). This satisfies the business secrecy requirements of the acquiring financial processor (300).

In one scenario of the example shown in FIG. 3, a Payment Request identifies a Payer Wallet ID, and a Payee Wallet ID (i.e., not directly identifying a Payer Account number and a Payee Account number). These electronic “wallets” may contain more than one payment method for the payer (e.g., check, cash, credit card, debit card, Stored Balance Financial Account ID, etc), and for the payee (e.g., DDA#, Stored Balance Financial Account ID, etc.) For a given Payment Request, the source of funds for the payer may default to Stored Balance if balance is available, then to DDA if the wallet contains a DDA, and then as a last resort to Credit Card. The destination of funds for the payee, is initially the Stored Balance Financial Account, then to either leave the funds in the Stored Balance Financial Account, or move them to a payee's DDA via the RCA (instant settlement), or via ACH (sweep settlement). Quite often the payer Wallet ID is an e-mail address, and the Instant Payment Service Provider will “reach into the Wallet identified by that e-mail address to pull out the appropriate Payment Account Numbers. A similar approach is used for the payee, where the Payee Wallet ID is typically a “Customer ID” that is sent with the Payment Request, where such a Customer ID also can take the form of an e-mail address.

In one or more embodiments, the acquiring financial processor (300) may use the architecture/method-of-operation described above to create a federated world-wide payments infrastructure, supporting instant money movement between financial accounts at different financial institutions within a single region or across federated instances of this architecture, where each instance serves a different region of the world, and each instance can support clearing or settlement or clearing plus settlement for a payment request

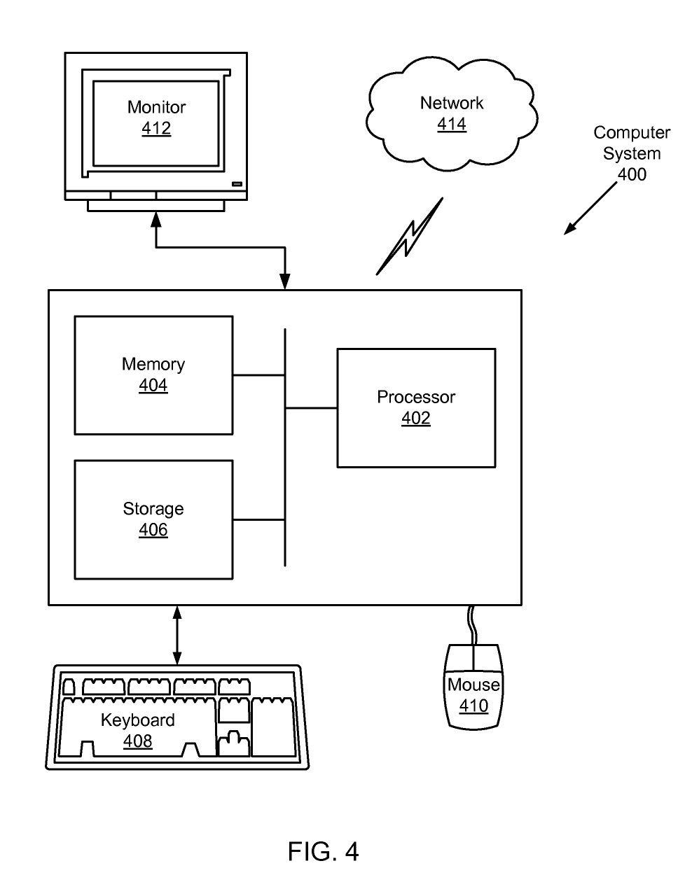

Embodiments of the invention may be implemented on virtually any type of computer regardless of the platform being used. For example, as shown in FIG. 4, a computer system (400) includes one or more computer processor(s) (402) such as a central processing unit (CPU), integrated circuit, or other hardware processor, associated memory (404) (e.g., random access memory (RAM), cache memory, flash memory, etc.), a storage device (406) (e.g., a hard disk, an optical drive such as a compact disk drive or digital video disk (DVD) drive, a flash memory stick, etc.), and numerous other elements and functionalities typical of today's computers (not shown). The computer system (400) may also include input means, such as a keyboard (408), a mouse (410), or a microphone (not shown). Further, the computer system (400) may include output means, such as a monitor ((412) (e.g., a liquid crystal display (LCD), a plasma display, or cathode ray tube (CRT) monitor). The computer system (400) may be connected to a network (414) (e.g., a local area network (LAN), a wide area network (WAN) such as the Internet, or any other similar type of network)) with wired and/or wireless segments via a network interface connection (414). Those skilled in the art will appreciate that many different types of computer systems exist, and the aforementioned input and output means may take other forms. Generally speaking, the computer system (400) includes at least the minimal processing, input, and/or output means necessary to practice embodiments of the invention.

Further, those skilled in the art will appreciate that one or more elements of the aforementioned computer system (400) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions for performing embodiments of the invention may be stored on a non-transitory computer readable storage medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to perform a payment, comprising:
receiving a request from a payer to pay a payee,
wherein the request comprises a payer account ID identifying a payer's payment account held at a payer financial institution and a payee account ID identifying a payee's payment account held at a payee financial institution, and
wherein the payer financial institution is external to the payee financial institution;
receiving, based on the payer account ID, a reservation confirmation that a payment amount is reserved from the payer's payment account;
retrieving, based on the payee account ID, a receiving clearing account (RCA) ID identifying an RCA held at the payee financial institution and controlled by a payment service provider; and
initiating, by a computer processor and in response to the reservation confirmation, a settlement process comprising:
transferring the payment amount from the RCA to the payee's payment account using a payee electronic funds transfer (EFT) capability of the payee's financial institution within a single business day of receiving the request by the payment service provider; and
debiting, in response to the transferring, the payment amount from the payer's payment account to reimburse the RCA.

2. The method of claim 1, wherein the settlement process further comprises:
reimbursing the RCA from the payer's payment account via a central clearing account (CCA) held at a sponsoring bank and controlled by the payment service provider; and
reimbursing the CCA from the payer's payment account.

3. The method of claim 1, further comprising:
retrieving, in response to identifying the payer's payment account as a deposit account based on the payer account ID, a sending clearing account (SCA) ID identifying an SCA that is held at the payer financial institution and controlled by the payment service provider; and
initiating a clearing process comprising:
transferring the payment amount from the deposit account to the SCA using a payer EFT capability of the payer's financial institution within a single business day of receiving the request by the payment service provider; and
reimbursing, from the SCA, a central clearing account (CCA) that is held at a sponsoring bank and controlled by the payment service provider,
wherein the reservation confirmation is based on completion of transferring the payment amount from the deposit account to the SCA, and
wherein the settlement process further comprises reimbursing the RCA from the CCA.

4. The method of claim 1, further comprising:
sending, in response to identifying the payer's payment account as a credit card account based on the payer account ID, an authorization request to a credit card authorization service provider to block the payment amount from the credit card account; and
initiating a clearing process comprising transferring the payment amount from the credit card account to a central clearing account (CCA) that is held at a sponsoring bank and controlled by the payment service provider,
wherein the reservation confirmation is based on receiving an authorization code from the credit card authorization processor confirming that the payment amount has been blocked from the credit card account, and
wherein the settlement process further comprises reimbursing the RCA from the CCA.

5. The method of claim 1, further comprises:
performing a clearing process using at least a clearing finite state machine (FSM) executing on the computer processor; and
performing the settlement process using at least a settlement FSM executing on the computer processor,
wherein the clearing process debits the amount of payment from the payer's payment account, and
wherein the clearing FSM and the settlement FSM are coupled based on the reservation confirmation.

6. The method of claim 1, further comprises:
crediting, in response at least to the reservation confirmation, the payment amount to a bookkeeping account maintained by the payment service provider for the payee; and
debiting the payment amount from the bookkeeping account when the payment amount is credited to the payee's payment account,
wherein the bookkeeping account is accessible by the payee.

7. The method of claim 6, further comprises:
receiving a failure indication of the settlement process;
changing a status of the amount of payment in the bookkeeping account from a transit status to a sweep status; and
transferring the payment amount from the payer's payment account to the payee's payment account via an overnight sweep process.

8. The method of claim 6, further comprises:
in response to a risk indication of the settlement process, and in lieu of the transferring and the debiting of the settlement process:
changing a status of the amount of payment in the bookkeeping account from a transit status to a pending status; and
crediting the payment amount to a stored balance financial account that is held at the payment service provider and represented by the bookkeeping account; and
transferring, in response to resolution of the risk indication, the payment amount from the stored balance financial account to the payee's payment account.

9. The method of claim 6, further comprises:
in response to an input from the payee, and in lieu of the transferring and the debiting of the settlement process, crediting the payment amount to a stored balance financial account that is held at the payment service provider.

10. A system to perform a payment, comprising:
a computer processor;
a payer financial institution comprising a payer's payment account controlled by a payer;
a payee financial institution, external to the payer financial institution, comprising a payee's payment account controlled by a payee and a receiving clearing account (RCA) controlled by a payment service provider; and
a payment platform core executing on the computer processor and configured to:
receive a request from a payer to pay a payee, wherein the request comprises a payer account ID identifying a payer's payment account held at a payer financial institution and a payee account ID identifying a payee's payment account held at a payee financial institution;
receive, based on the payer account ID, a reservation confirmation that a payment amount is reserved from the payer's payment account;
retrieve, based on the payee account ID, a receiving clearing account (RCA) ID identifying an RCA held at the payee financial institution and controlled by the payment service provider; and
initiate, in response to the reservation confirmation, a settlement process comprising:
transferring the payment amount from the RCA to the payee's payment account using a payee electronic funds transfer (EFT) capability of the payee's financial institution within a single business day of receiving the request by the payment service provider; and
debiting, in response to the transferring, the payment amount from the payer's payment account to reimburse the RCA.

11. The system of claim 10, wherein the settlement process further comprises:
reimbursing the RCA from the payer's payment account via a central clearing account (CCA) held at a sponsoring bank and controlled by the payment service provider; and
reimbursing the CCA from the payer's payment account.

12. The system of claim 10, the payment platform core further configured to:
retrieve, in response to identifying the payer's payment account as a deposit account based on the payer account ID, a sending clearing account (SCA) ID identifying an SCA that is held at the payer financial institution and controlled by the payment service provider; and
initiate a clearing process comprising:
transferring the payment amount from the deposit account to the SCA using a payer EFT capability of the payer's financial institution within a single business day of receiving the request by the payment service provider; and
reimbursing, from the SCA, a central clearing account (CCA) that is held at a sponsoring bank and controlled by the payment service provider,
wherein the reservation confirmation is based on completion of transferring the payment amount from the deposit account to the SCA, and
wherein the settlement process further comprises reimbursing the RCA from the CCA.

13. The system of claim 10, the payment platform core further configured to:
send, in response to identifying the payer's payment account as a credit card account based on the payer account ID, an authorization request to a credit card authorization service provider to block the payment amount from the credit card account; and
initiate a clearing process comprising transferring the payment amount from the credit card account to a central clearing account (CCA) that is held at a sponsoring bank and controlled by the payment service provider,
wherein the reservation confirmation is based on receiving an authorization code from the credit card authorization processor confirming that the payment amount has been blocked from the credit card account, and
wherein the settlement process further comprises reimbursing the RCA from the CCA.

14. The system of claim 10, the payment platform core further configured to:
perform a clearing process using at least a clearing finite state machine (FSM) executing on the computer processor; and
perform the settlement process using at least a settlement FSM executing on the computer processor,
wherein the clearing process debits the amount of payment from the payer's payment account, and
wherein the clearing FSM and the settlement FSM are coupled based on the reservation confirmation.

15. The system of claim 10, the payment platform core further configured to:
credit, in response at least to the reservation confirmation, the payment amount to a bookkeeping account maintained by the payment service provider for the payee; and
debit the payment amount from the bookkeeping account when the payment amount is credited to the payee's payment account,
wherein the bookkeeping account is accessible by the payee.

16. The system of claim 15, the payment platform core further configured to:
receive a failure indication of the settlement process;
change a status of the amount of payment in the bookkeeping account from a transit status to a sweep status; and
transfer the payment amount from the payer's payment account to the payee's payment account via an overnight sweep process.

17. The system of claim 15, the payment platform core further configured to:
in response to a risk indication of the settlement process, and in lieu of the transferring and the debiting of the settlement process:
change a status of the amount of payment in the bookkeeping account from a transit status to a pending status; and
credit the payment amount to a stored balance financial account that is held at the payment service provider and represented by the bookkeeping account; and
transfer, in response to resolution of the risk indication, the payment amount from the stored balance financial account to the payee's payment account.

18. The system of claim 15, the payment platform core further configured to:
in response to an input from the payee, and in lieu of the transferring and the debiting of the settlement process:
credit the payment amount to a stored balance financial account that is held at the payment service provider and represented by the bookkeeping account.

19. A non-transitory computer readable medium storing instructions to perform a payment, the instructions, when executed by a computer processor, comprising functionality for:
receiving a request from a payer to pay a payee,
wherein the request comprises a payer account ID identifying a payer's payment account held at a payer financial institution and a payee account ID identifying a payee's payment account held at a payee financial institution, and
wherein the payer financial institution is external to the payee financial institution;
receiving, based on the payer account ID, a reservation confirmation that a payment amount is reserved from the payer's payment account;
retrieving, based on the payee account ID, a receiving clearing account (RCA) ID identifying an RCA held at the payee financial institution and controlled by a payment service provider; and
initiating, in response to the reservation confirmation, a settlement process comprising:
transferring the payment amount from the RCA to the payee's payment account using a payee electronic funds transfer (EFT) capability of the payee's financial institution within a single business day of receiving the request by the payment service provider; and
debiting, in response to the transferring, the payment amount from the payer's payment account to reimburse the RCA.

20. The non-transitory computer readable medium of claim 19, wherein the settlement process further comprises:
reimbursing the RCA from the payer's payment account via a central clearing account (CCA) held at a sponsoring bank and controlled by the payment service provider; and
reimbursing the CCA from the payer's payment account.

21. The non-transitory computer readable medium of claim 19, the instructions, when executed by the computer processor, further comprising functionality for:
retrieving, in response to identifying the payer's payment account as a deposit account based on the payer account ID, a sending clearing account (SCA) ID identifying an SCA that is held at the payer financial institution and controlled by the payment service provider; and
initiating a clearing process comprising:
transferring the payment amount from the deposit account to the SCA using a payer EFT capability of the payer's financial institution within a single business day of receiving the request by the payment service provider; and
reimbursing, from the SCA, a central clearing account (CCA) that is held at a sponsoring bank and controlled by the payment service provider,
wherein the reservation confirmation is based on completion of transferring the payment amount from the deposit account to the SCA, and
wherein the settlement process further comprises reimbursing the RCA from the CCA.

22. The non-transitory computer readable medium of claim 19, the instructions, when executed by the computer processor, further comprising functionality for:
sending, in response to identifying the payer's payment account as a credit card account based on the payer account ID, an authorization request to a credit card authorization service provider to block the payment amount from the credit card account; and
initiating a clearing process comprising transferring the payment amount from the credit card account to a central clearing account (CCA) that is held at a sponsoring bank and controlled by the payment service provider,
wherein the reservation confirmation is based on receiving an authorization code from the credit card authorization processor confirming that the payment amount has been blocked from the credit card account, and
wherein the settlement process further comprises reimbursing the RCA from the CCA.

23. The non-transitory computer readable medium of claim 19, the instructions, when executed by the computer processor, further comprising functionality for:
performing a clearing process using at least a clearing finite state machine (FSM) executing on the computer processor; and
performing the settlement process using at least a settlement FSM executing on the computer processor,
wherein the clearing process debits the amount of payment from the payer's payment account, and
wherein the clearing FSM and the settlement FSM are coupled based on the reservation confirmation.

24. The non-transitory computer readable medium of claim 19, the instructions, when executed by the computer processor, further comprising functionality for:
crediting, in response at least to the reservation confirmation, the payment amount to a bookkeeping account maintained by the payment service provider for the payee; and
debiting the payment amount from the bookkeeping account when the payment amount is credited to the payee's payment account,
wherein the RCA is not accessible by the payee, and
wherein the bookkeeping account is accessible by the payee.

25. The non-transitory computer readable medium of claim 24, the instructions, when executed by the computer processor, further comprising functionality for:
receiving a failure indication of the settlement process;
changing a status of the amount of payment in the bookkeeping account from a transit status to a sweep status; and
transferring the payment amount from the payer's payment account to the payee's payment account via an overnight sweep process.

26. The non-transitory computer readable medium of claim 24, the instructions, when executed by the computer processor, further comprising functionality for:
in response to a risk indication of the settlement process, and in lieu of the transferring and the debiting of the settlement process:
changing a status of the amount of payment in the bookkeeping account from a transit status to a pending status; and
crediting the payment amount to a stored balance financial account that is held at the payment service provider and represented by the bookkeeping account; and
transferring, in response to resolution of the risk indication, the payment amount from the stored balance financial account to the payee's payment account.

27. The non-transitory computer readable medium of claim 24, the instructions, when executed by the computer processor, further comprising functionality for:
in response to an input from the payee, and in lieu of the transferring and the debiting of the settlement process:
crediting the payment amount to a stored balance financial account that is held at the payment service provider and represented by the bookkeeping account.
